(19) United States
(12) Patent Application Publication
(10) Pub. No.: US 2021/0223367 A1
(43) Pub. Date: Jul. 22, 2021

(54) Laser Radar and Scanning Method Thereof

(71) Applicant: Shanghai Harvest Intelligence Technology Co., Ltd., Shanghai (CN)

(72) Inventor: Jiandong HUANG, Shanghai (CN)

(73) Assignee: Shanghai Harvest Intelligence Technology Co., Ltd., Shanghai (CN)

(21) Appl. No.: 17/150,213

(22) Filed: Jan. 15, 2021

(30) Foreign Application Priority Data
Jan. 16, 2020 (CN) 202010049534.9

(51) Int. Cl. G01S 7/481; G01S 17/89; G02B 26/10; G02F 1/13

(52) U.S. Cl. CPC G01S 7/4817; G02F 1/1313; G02B 26/101; G01S 17/89

(57) ABSTRACT

The present disclosure provides a laser radar and a scanning method thereof. The laser radar includes a laser generation module configured for generating a first optical signal; and a scanning module configured for acquiring the first optical signal and outputting a second optical signal. There is an angle between a transmission direction of the second optical signal and a transmission direction of the first optical signal, and the angle is adjustable. The scanning module includes a liquid crystal layer for adjusting the angle to scan a target space. With solutions of the present disclosure, space scanning can be realized without an additional motion module, which can effectively improve the stability of the laser radar, and achieve low cost and fast scanning speed.

### CROSS-REFERENCE TO RELATED APPLICATIONS

The present application claims the benefit of priority to Chinese patent application No. 202010049534.9, filed on Jan. 16, 2020, entitled “Laser Radar and Scanning Method Thereof”, the entire disclosures of which are incorporated herein by reference.

### TECHNICAL FIELD

The present disclosure relates to the technical field of laser radar, and more particularly to a laser radar and a scanning method using the laser radar.

### BACKGROUND

Generally, there are two kinds of scanning modules in existing laser radar field, one is to scan a target space by rotating a light source and a detector simultaneously through a mechanical mechanism such as a rotor, and the other is to scan the target space by changing an emitting direction of laser beams emitted by the light source through a micro-electro-mechanical system (MEMS) such as a galvanometer.

In both scanning modules, a motion module is needed to change the emitting direction of the laser beams, however, the motion module inevitably vibrates during the motion, which affects the stability of the laser radar. In order to improve the stability, the motion module can only drive the light source to rotate at a quite low speed, which results in a slow scanning speed for the existing mechanical spatial scanning mode. On the other hand, MEMS also has the problem of high cost.

### SUMMARY

Embodiments of the present disclosure provide a laser radar, i.e. lidar, without a motion module, in order to improve the stability while taking into account low cost and faster scanning speed.

An embodiment of the present disclosure provides a laser radar, including: a laser generation module configured for generating a first optical signal; and a scanning module configured for acquiring the first optical signal and outputting a second optical signal. There is an angle between a transmission direction of the second optical signal and a transmission direction of the first optical signal, and the angle is adjustable. The scanning module includes a liquid crystal layer configured for adjusting the angle to scan a target space.

In some embodiments, the second optical signal scans the target space in a first scanning plane, the laser radar further includes a shaper configured for acquiring the second optical signal and outputting a single or a plurality of third optical signals, and the single or the plurality of third optical signals are in a second scanning plane.

In some embodiments, the first optical signal includes a single or a plurality of incident light beams, the second optical signal includes a single or a plurality of deflected light beams having a one-to-one correspondence to the single or the plurality of incident light beams, and the shaper is configured for acquiring at least a part of the deflected light beams and output the single or the plurality of third optical signals.

In some embodiments, the liquid crystal layer is configured for adjusting the angle under a voltage input.

In some embodiments, the scanning module further includes a voltage input module configured to apply a voltage to at least a portion of the liquid crystal layer.

In some embodiments, the angle between the transmission direction of the second optical signal and the transmission direction of the first optical signal is determined according to one or more of following parameters: a refractive index of the liquid crystal layer before and after the voltage is applied; for the at least a portion of the liquid crystal layer applied with the voltage, a change of the refractive index of the at least a portion of the liquid crystal layer when the voltage is applied compared with the refractive index of the at least a portion of the liquid crystal layer when the voltage is not applied; an incident angle of the first optical signal on an interface on which the first optical signal is refracted and converted into the second optical signal; and an emergence angle of the second optical signal on the interface.

In some embodiments, the voltage input module includes a first electrode and a second electrode, and the voltage is applied to the liquid crystal layer via the first electrode and the second electrode.

In some embodiments, the first electrode and the second electrode are oppositely disposed on the same side or both sides of the liquid crystal layer along a longitudinal direction, and there is a non-zero angle between the longitudinal direction and the transmission direction of the first optical signal.

In some embodiments, in addition to a surface facing the first electrode and the second electrode, the liquid crystal layer further includes a plurality of surfaces, the first optical signal is transmitted to the liquid crystal layer from any of the plurality of surfaces, and the second optical signal is emitted from any of the plurality of surfaces.

In some embodiments, the first electrode and the second electrode are respectively in contact with the at least a portion of the liquid crystal layer, and an outer profile of a contact surface of the first electrode and/or the second electrode with the at least a portion of the liquid crystal layer is defined by a closed curve with a preset geometric shape.

In some embodiments, the first electrode includes a plurality of first sub-electrodes, the second electrode includes a plurality of second sub-electrodes, and the plurality of first sub-electrodes and the plurality of second sub-electrodes are disposed opposite to each other on the same side or both sides of the liquid crystal layer along the longitudinal direction; each first sub-electrode, each corresponding second sub-electrode and an area of the liquid crystal layer between the first sub-electrode and the corresponding second sub-electrode along the longitudinal direction form a deflection unit, and each first sub-electrode and each corresponding second sub-electrode are configured to apply a voltage to the area of the liquid crystal layer therebetween; and wherein along a light path a first deflection unit of a plurality of deflection units is configured to acquire the first optical signal, a last deflection unit of the plurality of deflection units is configured to output the second optical signal, an input optical signal of a particular deflection unit of the plurality of deflection units comes from an output optical signal of a deflection unit in front of the particular deflection unit, and for each deflection unit, there is an angle between a propagation direction of the output optical signal output by the deflection unit and a propagation direction of the input optical signal acquired by the deflection unit.

In some embodiments, the plurality of deflection units include a first group of deflection units and a second group of deflection units, and the angle between propagation directions of the output optical signal and the input optical signal of each deflection unit included in the first group of deflection units is different from the angle between propagation directions of the output optical signal and the input optical signal of each deflection unit included in the second group of deflection units.

In some embodiments, the first sub-electrodes and the second sub-electrodes of different deflection units apply different voltages to the areas of the liquid crystal layer therebetween.

In some embodiments, the first optical signal includes a plurality of incident light beams, the second optical signal includes a plurality of deflected light beams having a one-to-one correspondence to the plurality of incident light beams; wherein the first electrode includes a plurality of first sub-electrodes, the second electrode includes a plurality of second sub-electrodes, and the plurality of first sub-electrodes and the plurality of second sub-electrodes are disposed opposite to each other on both sides of the liquid crystal layer along the longitudinal direction; wherein each first sub-electrode, each corresponding second sub-electrode and an area of the liquid crystal layer between the first sub-electrode and the corresponding second sub-electrode along the longitudinal direction form a deflection unit, each first sub-electrode and each corresponding second sub-electrode are configured to apply a voltage to the area of the liquid crystal layer therebetween, and each deflection unit is configured to acquire a corresponding incident light beam and outputting a deflected light beam.

In some embodiments, for each deflection unit, a transmission direction of the deflected light beam output by the deflection unit changes with change of the voltage applied to the deflection unit to form a sub-scanning plane, and a plurality of sub-scanning planes formed by a plurality of deflection units cover a scanning plane of the scanning module.

In some embodiments, the plurality of sub-scanning planes formed by different deflection units have different areas.

In some embodiments, the laser radar further includes a beam splitter configured for converting a single laser beam generated by the laser generation module into the plurality of incident light beams; or the laser generation module includes a plurality of laser devices, wherein each laser device is configured to generate a laser beam, and a plurality of laser beams generated by the plurality of laser devices form the plurality of incident light beams.

In some embodiments, the laser radar further includes a cover plate disposed on one or both sides of the liquid crystal layer along the longitudinal direction, wherein the first electrode and the second electrode are disposed on the cover plate.

In some embodiments, the laser radar further includes a plurality of scanning modules, wherein there is an orthogonal relationship among scanning planes of the plurality of scanning modules

In some embodiments, the liquid crystal layer is made of a material including a blue phase liquid crystal material.

Another embodiment of the present disclosure provides a scanning method of the laser radar, including: receiving a scanning instruction; scanning the target space based on the second optical signal generated by the scanning module; and acquiring a reflection information of the second optical signal in the target space to obtain a scanning result of the target space.

In some embodiments, the scanning method further includes: applying the voltage to the liquid crystal layer in response to receiving a scanning instruction, wherein the voltage changes according to a preset waveform and a preset frequency.

In some embodiments, the preset frequency is greater than 0 and less than or equal to 10 KHz; and/or the preset waveform includes a pulse wave or a nonlinear wave.

In some embodiments, a change of the angle is positively related to a waveform and a change of the voltage, a change of the refractive index of the liquid crystal layer is positively related to the waveform and the change of the voltage, and the change of the refractive index of the liquid crystal layer refers to the change of the refractive index of a portion of the liquid crystal layer when the voltage is applied compared with the refractive index of the portion of the liquid crystal layer when the voltage is not applied.

Compared with conventional technologies, embodiments of the present disclosure have following beneficial effects.

An embodiment of the present disclosure provides a laser radar, including: a laser generation module configured for generating a first optical signal; and a scanning module configured for acquiring the first optical signal and outputting a second optical signal. There is an angle between a transmission direction of the second optical signal and a transmission direction of the first optical signal, and the angle is adjustable. The scanning module includes a liquid crystal layer configured for adjusting the angle to scan a target space.

Compared with the existing laser radar for achieving spatial scanning based on a special motion module, the laser radar provided by the embodiments of the present disclosure changes the emitting direction of the laser beam by applying voltage to drive liquid crystal, and can complete the scanning of the target space without a motion module. Further, since the scanning module changes the emitting direction of the laser beam by changing a molecular structure of the liquid crystal layer, the scanning module itself does not move, which can effectively improve the stability of the laser radar, and achieve low cost and fast scanning speed.

Further, the second optical signal scans the target space in a first scanning plane, and the laser radar further includes a shaper configured for acquiring the second optical signal and outputting a single or a plurality of third optical signals, and the single or the plurality of third optical signals are in a second scanning plane. Further, the second scanning plane has a non-zero angle relative to the first scanning plane. Therefore, scanning in two different planes can be realized through an optical shaping, thereby realizing three-dimensional spatial scanning, which is low in cost and easy to implement.

Further, the first optical signal includes a single or a plurality of incident light beams, the second optical signal includes a single or a plurality of deflected light beams having a one-to-one correspondence to the single or the plurality of incident light beams. The first electrode includes a plurality of first sub-electrodes, the second electrode includes a plurality of second sub-electrodes, and the plurality of first sub-electrodes and the plurality of second sub-electrodes are disposed opposite to each other on both sides of the liquid crystal layer along the longitudinal direction. Each first sub-electrode, each corresponding second sub-electrode and an area of the liquid crystal layer between the first sub-electrode and the corresponding second sub-electrode along the longitudinal direction form a deflection unit, each first sub-electrode and each corresponding second sub-electrode are configured to apply a voltage to the area of the liquid crystal layer therebetween, and each deflection unit is configured to acquire a corresponding incident light beam and outputting a deflected light beam. Therefore, the scanning plane can be formed by a liquid crystal scanning array, and since a sub-scanning unit formed by each deflection unit can be relatively small, the voltage of each deflection unit can be appropriately reduced, which is beneficial to reduce the power consumption of the laser radar.

Further, for each deflection unit, a transmission direction of the deflected light beam output by the deflection unit changes with change of the voltage applied to the deflection unit to form a sub-scanning plane, and a plurality of sub-scanning planes formed by a plurality of deflection units cover a scanning plane of the scanning module. Therefore, the multi-beam-based liquid crystal scanning array can be applied to high-speed application scenarios. Since a single scanning stroke of a single deflected light beam is only in the corresponding sub-scanning plane, the time for completing a single scanning is greatly reduced, which is beneficial to optimize the scanning frequency of the laser radar.

Another embodiment of the present invention also provides a scanning method using the laser radar, including: receiving a scanning instruction; scanning the target space based on the second optical signal generated by the scanning module; and acquiring a reflection information of the second optical signal in the target space to obtain a scanning result of the target space. Therefore, the scanning of the target space can be completed without an additional motion module. and overall scanning scheme has high stability, low cost and fast scanning speed.

### BRIEF DESCRIPTION OF THE DRAWINGS

FIG. 1 is a schematic diagram of the principle of a laser radar according to an embodiment of the present disclosure;

FIG. 2 is a schematic diagram of a first structure of a scanning module in FIG. 1;

FIG. 3 is a top view of the scanning module shown in FIG. 2;

FIG. 4 is a top view of a second structure of the scanning module in FIG. 1;

FIG. 5 is a partial schematic diagram of the principle of a laser radar according to another embodiment of the present disclosure;

FIG. 6 is a side view of the laser radar shown in FIG. 5 in a typical application scenario;

FIG. 7 is a top view of the laser radar shown in FIG. 5 in a typical application scenario;

FIG. 8 is a partial schematic diagram of the principle of a laser radar according to still another embodiment of the present disclosure; and

FIG. 9 is a flowchart of a scanning method of a laser radar according to an embodiment of the present disclosure.

### DETAILED DESCRIPTION

As mentioned in the background art, the existing laser radar requires a motion module to achieve scanning of the target space. When the motion module drives the light source to rotate to change the emitting direction of the laser beam, the motion module will inevitably shake, which results in poor stability and low scanning speed, and some motion modules have high cost, which is not conducive to market popularization.

In order to resolve above technical problems, an embodiment of the present disclosure provides a laser radar, including: a laser generation module configured for generating a first optical signal; and a scanning module configured for acquiring the first optical signal and outputting a second optical signal, wherein there is an angle between a transmission direction of the second optical signal and a transmission direction of the first optical signal, and the angle is adjustable; wherein the scanning module includes a liquid crystal layer configured for adjusting the angle to scan a target space. In some embodiments, the angle is a non-zero angle.

The laser radar provided by the embodiments of the present disclosure changes the emitting direction of the laser beam by applying voltage to drive liquid crystal, and can complete the scanning of the target space without a motion module. Further, since the scanning module changes the emitting direction of the laser beam by changing a molecular structure of the liquid crystal layer, the scanning module itself does not move, which can effectively improve the stability of the laser radar, and achieve low cost and fast scanning speed.

In order to make above objectives, features and beneficial effects of the present disclosure more obvious and understandable, specific embodiments of the present disclosure will be described in detail below with reference to the accompanying drawings.

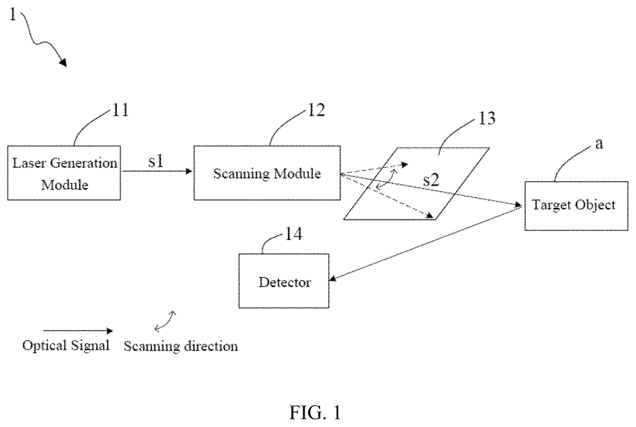

Next, embodiments of the present disclosure will be described in detail with reference to the drawings. The same part is marked with the same reference number in each figure. Each embodiment is merely an illustration, and the structures shown in different embodiments can be partially replaced or combined. In variation examples, the descriptions of matters common to the embodiment shown in FIG. 1 is omitted, and only the differences are described. In particular, the same effect produced by the same structure will not be mentioned one by one for each embodiment.

FIG. 1 is a schematic diagram of the principle of a laser radar 1 according to an embodiment of the present disclosure.

Specifically, the laser radar described in this embodiment may be applied to a scanning scene for a target space, and the target space may be two-dimensional or three-dimensional. The scanning result of the target space can be applied in various fields such as distance measurement and virtual reality (VR) imaging.

In some embodiments, referring to FIG. 1, the laser radar 1 may include a laser generation module 11 configured for generating a first optical signal s1, and a transmission direction of the first optical signal s1 is recorded as a first direction.

The laser generation module 11 may be configured to output a laser beam, for example, a laser. In some embodiments, the laser beam output by the laser generation module 11 is recorded as the first optical signal s1.

In some embodiments, the first direction of the first optical signal s1 may be constant. That is, during the operation of the laser radar 1, an emitting direction of the laser beam emitted by the laser generation module 11 is not changed, and the laser generation module 11 itself does not undergo mechanical movement such as rotation.

In some embodiments, still referring to FIG. 1, the laser radar 1 may further include a scanning module 12. The scanning module 12 is disposed in front of the laser generation module 11 along the first direction. The scanning module 12 is configured to acquire the first optical signal s1 and output a second optical signal s2, and a transmission direction of the second optical signal s2 is recorded as a second direction. There is an angle between the second direction and the first direction, and the angle is adjustable.

Specifically, the scanning module 12 is configured to change the transmission direction of the first optical signal s1, so that the transmission direction of the second optical signal s2 emitted from the scanning module 12 can move back and forth in a specific plane (such as a first scanning plane 13) to realize the spatial scanning of a target object a.

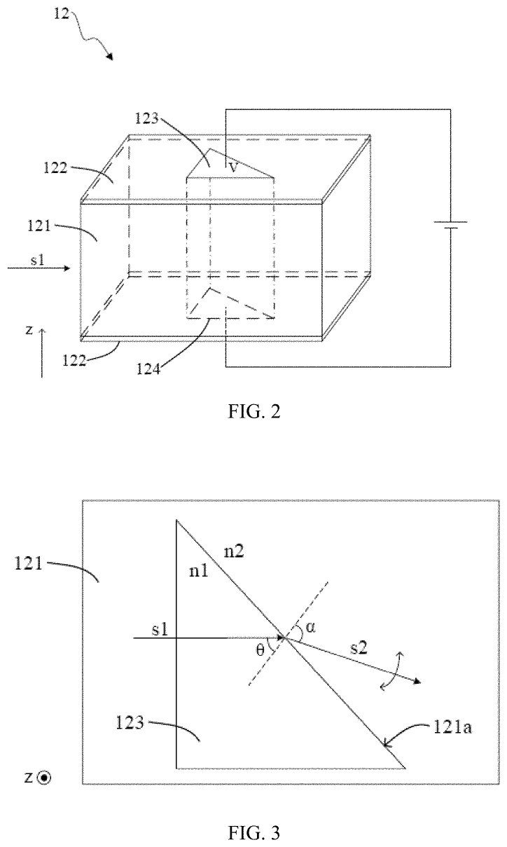

Different from the conventional technologies, the scanning module 12 itself does not undergo mechanical movement such as rotation, but adjusts the angle by changing the voltage applied to a liquid crystal layer 121 in the scanning module 12 (shown in FIG. 2). Moreover, since the deflection is caused by a molecular-level movement of a liquid crystal material in the liquid crystal layer 121, there is no rotation or other movement in the laser radar 1 on a macroscopic scale, and the laser radar 1 itself has no mechanical movement, which can effectively guarantee the overall stability of the laser radar 1.

In some embodiments, still referring to FIG. 1, the laser radar 1 may also include a detector 14 for receiving an optical signal reflected from the target object a to obtain the scanning result of the target space. The optical signal reflected from the target object a may be an optical signal reflected by the second optical signal s2 irradiating the target object a. Alternatively, the optical signal reflected from the target object a may also be an optical signal reflected by the second optical signal s2 irradiating the target object a after being optically modulated, for example, a third optical signal s3 described below.

Next, the structure of the scanning module 12 will be described in detail with reference to FIGS. 2 and 3.

FIG. 2 is a schematic diagram of a first structure of the scanning module 12 in FIG. 1, and FIG. 3 is a top view of the scanning module shown in FIG. 2.

Referring to FIG. 2, the scanning module 12 may include a liquid crystal layer 121 and cover plates 122 respectively disposed on both sides of the liquid crystal layer 121 along the longitudinal direction (z direction in the figure). Along the z direction shown in the figure, a cover plate 122 disposed above the liquid crystal layer 121 is called as an upper cover, and a cover plate 122 disposed below the liquid crystal layer 121 is called as a lower cover.

For example, the cover plates 122 may be made of a glass material.

Further, the scanning module 12 may also include a voltage input module. The voltage input module may include a first electrode 123 and a second electrode 124. The first electrode 123 may be disposed on the upper cover plate, and the second electrode 124 may be disposed on the lower cover plate. In addition, the first electrode 123 and the second electrode 124 are disposed oppositely on both sides of the liquid crystal layer 121 along the longitudinal direction (the z direction in the figure, i.e., an arrangement direction of the first electrode 123, the cover plates 122 and the second electrode 124). That is, the direction from the first electrode 123 to the second electrode 124 is parallel to the longitudinal direction (the z direction in the figure).

For example, both the first electrode 123 and the second electrode 124 may be formed on the corresponding cover plate 122 by electroplating.

In some embodiments, the first electrode 123 and the second electrode 124 may be oppositely disposed on the upper cover plate or the lower cover plate. At this time, the first electrode 123 and the second electrode 124 are oppositely disposed on the same side of the liquid crystal layer 121 along the z direction. Specifically, it can be implemented using in-plane switching (IPS) technology. For example, referring to FIG. 2, two electrodes may be disposed separately on the upper cover plate or the lower cover plate along the first direction, and the two electrodes disposed separately are the first electrode 123 and the second electrode 124.

Further, in some embodiments, the cover plate 122 may be disposed only on the side of the liquid crystal layer 121 provided with the electrodes.

In some embodiments, referring to FIGS. 2 and 3, there is an angle between the longitudinal direction (the z direction shown in the figure) and the first direction, and the angle is non-zero, so that the first optical signal s1 can be smoothly incident on the liquid crystal layer 121 without being blocked by the first electrode 123 or the second electrode 124.

It should be noted that FIGS. 2 and 3 illustrate an example in which the first direction is perpendicular to the z direction. In practical applications, on the premise of ensuring that the first optical signal s1 passes through an area of the liquid crystal layer 121 between the first electrode 123 and the second electrode 124, the first direction may also have an angle of 30° or 60° relative to the z direction.

Further, the second direction changes with the change of the voltage V to form the first scanning plane 13 (as shown in FIG. 1), so as to realize the scanning of the target space. The voltage input module is coupled to the liquid crystal layer 121, so that the voltage V is a voltage applied to the liquid crystal layer 121 through the first electrode 123 and the second electrode 124, and the first scanning plane 13 is perpendicular to the longitudinal direction (the z direction in the figure).

Specifically, the first scanning plane 13 may be a sector.

For example, the first electrode 123 and the second electrode 124 may be coupled with an external power supply to apply the voltage V to the liquid crystal layer 121.

In some embodiments, the first scanning plane 13 may be parallel to a horizontal plane. At this time, the z direction may be a gravity direction, and the first direction may be a horizontal direction.

In some embodiments, the angle between the first scanning plane 13 and the horizontal plane may be adjusted by adjusting the angle between the first direction and the horizontal direction, the angle between the longitudinal direction (the z direction shown in the figure) and the gravity direction, and/or a direction of molecular arrangement of the liquid crystal material in the liquid crystal layer 121, so that the laser radar 1 can be applied to the scanning space with complex structure. For example, the angle between the first scanning plane 13 and the horizontal plane is adjusted to avoid obstacles at specific positions in the scanning space, so as to ensure the accurate scanning of the target object a.

For example, when scanning the target object a at a lower position, the first scanning plane 13 may be inclined downward relative to the horizontal plane, so that the first scanning plane 13 can effectively cover the area where the target object a is located.

For another example, when the z direction is a transverse direction and perpendicular to the first direction, it is equivalent to that the scanning module 12 shown in FIG. 2 is rotated by 90 degrees with the first direction as an axis. At this time, the first scanning plane 13 may be a vertical plane (that is, perpendicular to the horizontal plane), and the laser radar 1 can scan the target object a at different heights in front of the laser radar 1.

In some embodiments, the first electrode 123 and the second electrode 124 have a polygonal cross-section along the first scanning plane 13.

For example, FIG. 2 and FIG. 3 illustrate that the first electrode 123 and the second electrode 124 have a triangular cross-section along the first scanning plane 13.

In some embodiments, the cross-sections of the first electrode 123 and the second electrode 124 along the first scanning plane 13 may have a circular shape, a rectangular shape, a pentagonal shape or other shapes.

In some embodiments, contact surfaces of the first electrode 123 and the second electrode 124 with the liquid crystal layer 121 may have an outer profile defined by a closed curve having a preset geometric shape. The closed curve may be a closed smooth curve, the preset geometric shape may be a circular shape, a polygonal shape, or an irregular geometric shape, and the polygonal shape be a triangle, a rectangle, or a pentagon.

In some embodiments, the first electrode 123 and the second electrode 124 may be respectively in contact with at least a portion of the liquid crystal layer 121, so as to change the refractive index of a contact portion of the liquid crystal layer 121 by applying the voltage.

In some embodiments, on the basis of ensuring a sufficient angle, the areas of the cross-sections of the first electrode 123 and the second electrode 124 along the first scanning plane 13 may be reduced as much as possible so as to reduce the overall volume of the laser radar 1.

In some embodiments, still referring to FIGS. 1 to 3, the angle (denoted as Δα) of the second direction relative to the first direction can be determined according to one or more of following parameters: a refractive index of the liquid crystal layer 121 before and after the voltage V is applied; for the at least a portion of the liquid crystal layer 121 applied with the voltage, a change An between a refractive index n1 of the at least a portion of the liquid crystal layer 121 after the voltage V is applied and a refractive index n2 of the at least a portion of the liquid crystal layer 121 before the voltage is applied; an incident angle θ of the first optical signal s1 on an interface 121a, wherein the critical interface 121a is an interface of areas with different refractive indexes in the liquid crystal layer 121, and the first optical signal s1 is refracted on the critical surface 121a and converted into the second optical signal s2; and an emergence angle α of the second optical signal s2 on the interface 121a. The interface 121a is an interface of arears with different refractive indexes in the liquid crystal layer 121.

Specifically, it is assumed that the refractive index of the liquid crystal material filled in the liquid crystal layer 12 is n2 when the voltage V is not applied, and the refractive index is n1 after the voltage V is applied.

Referring to FIG. 3, when the voltage V is applied, the liquid crystal material in an area (indicated by a triangular prism depicted by dashed dotted lines) of the liquid crystal layer 121 between triangular first electrode 123 and triangular second electrode 124 along the longitudinal direction (the z direction as shown) is deflected under the application of the voltage V, so that the refractive index of the liquid crystal layer 121 in the area of the triangular prism is n1. Since the liquid crystal material of the liquid crystal layer 121 outside the area of the triangular prism is not affected by the voltage V, the refractive index is still n2.

That is, the change of the refractive index is Δn=|n2−n1|. In addition, the magnitude of the change An of the refractive index may change with the change of the voltage V. For example, the greater the voltage V, the greater the change An of the refractive index.

Further, according to the shape of the electrodes shown in FIGS. 2 and 3 (for example, a right triangle) and the incident angle of the first optical signal s1, the interface 121a is a longitudinal connecting surface of the hypotenuses of the right triangles of the first electrode 123 and the second electrode 124.

At this time, the first optical signal s1 is emitted from the triangular prism and refracted when entering other areas of the liquid crystal layer 121, the refracted optical signal is the second optical signal s2.

An angle between the first optical signal s1 and a normal perpendicular to the interface 121a is recorded as the incident angle θ, and an angle between the second optical signal s2 and the normal is recorded as the emergence angle α.

According to the principle of optical refraction, an equation may be obtained: n1×sin θ=n2×sin α; further, Δn×sin θ˜n2×cos α×Δα, where “˜” refers to positive correlation. Thus, the angle between the second direction and the first direction can be calculated as follows: Δa˜(Δn/n1)×tan α.

Based on above analysis, the change An of the refractive index of the liquid crystal layer 121 is related to the voltage V. Therefore, by adjusting the voltage V, the deflection degree of the second optical signal s2 relative to the first optical signal s1 can be controlled. For example, in a single scanning process, the voltage V may be gradually increased so that the second optical signal S2 is deflected in a specific direction to complete the scanning of the target space. The specific direction may be deflected on the first scanning plane 13 clockwise or counterclockwise.

Furthermore, by designing the first electrode 123 and the second electrode 124, the emergence angle α can be adjusted, which can also achieve the effect of adjusting the angle αα.

In some embodiments, the first electrode 123 and the second electrode 124 can basically cover both sides of the liquid crystal layer 121 along the z direction. At this time, the interface 121a is any one of four planes parallel to the z direction of a cubic liquid crystal layer 121 in FIG. 2, and the angle Δα of the second direction relative to the first direction can be determined according to the refractive index of the air and the refractive index of the liquid crystal material in the crystal layer 121 under the voltage V.

In some embodiments, when the first optical signal s1 is incident on the area of the triangular prism from the area of the liquid crystal layer 121 to which the voltage V is not applied, the first optical signal s1 can be incident perpendicular to an incident plane, so that the first optical signal s1 does not refract when it is incident on the triangular prism, but is refracted when it is emitted from the triangular prism.

In some embodiments, by changing the shapes of the first electrode 123 and the second electrode 124, and/or the incident angle of the first optical signal s1, the first optical signal s1 can refract once when it enters the area of the triangular prism, and refract again when it leaves the area of the triangular prism, so as to increase the angle Aa of the second direction relative to the first direction.

From the above, the laser radar 1 applies voltage to drive liquid crystal to change the emergence direction of the laser beam, which can complete the scanning of the target space without an additional motion module. Moreover, since the scanning module 12 changes the emergence direction of the laser beam by changing the molecular structure of the liquid crystal layer 121, the scanning module 12 itself does not move, which can effectively improve the stability of laser radar 1 and achieve low cost and fast scanning speed.

Specifically, the solution of this embodiment utilizes the characteristic of the liquid crystal to change its orientation with voltage, so that the second direction of the second optical signal s2 emitted from the liquid crystal layer 121 is deflected relative to the first direction of the first optical signal s1 when it is incident. On this basis, sector scanning is achieved by changing the voltage V applied to the liquid crystal layer 121.

In some embodiments, in addition to one or both sides of the first electrode 123 and the second electrode 124, the liquid crystal layer 121 may also include a plurality of surfaces, and the first optical signal s1 may be transmitted from any of the plurality of surfaces to the liquid crystal layer 121, and the second optical signal s2 may be emitted from any one of the plurality of surfaces.

For example, by adjusting the voltage V, and/or the shapes and areas of the first electrode 123 and the second electrode 124, the first optical signal s1 and the second optical signal s2 may enter and exit from the same surface. In other words, the first scanning plane 13 may not be limited to a sector area in front of the scanning module 12, but may be expanded to an entire plane taking the scanning module 12 as the center. As a result, the laser radar 1 can perform 360° omnidirectional scanning for the space where it is located.

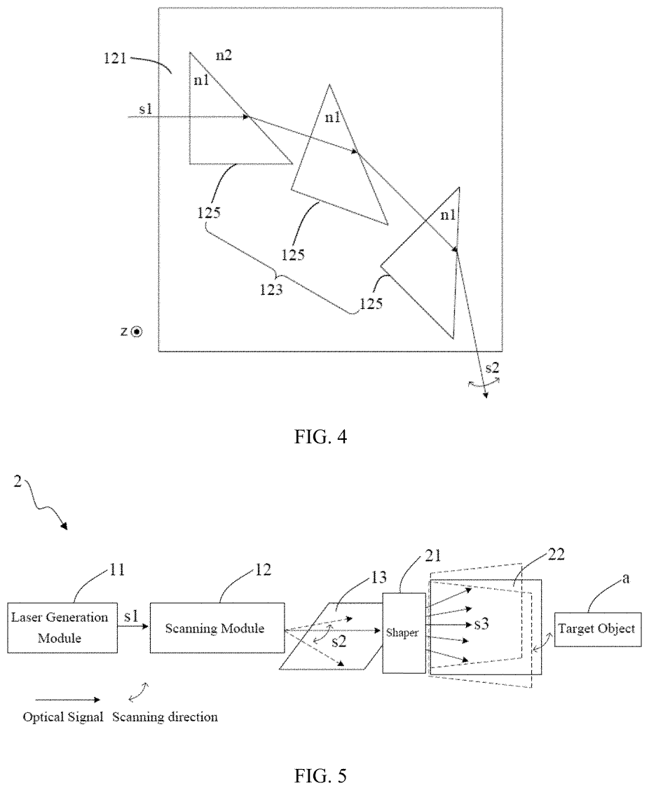

In some embodiments, referring to FIG. 4, the first electrode 123 may include a plurality of first sub-electrodes 125, and the second electrode 124 may include a plurality of second sub-electrodes (not shown). The plurality of first sub-electrodes 125 and the plurality of second sub-electrodes are arranged opposite to each other on both sides of the liquid crystal layer 121 along the longitudinal direction (the z direction in the figure).

Each first sub-electrode 125, each corresponding second sub-electrode and an area of the liquid crystal layer 121 between the first sub-electrode 125 and the second sub-electrode along the longitudinal direction (the z direction in the figure) form a deflection unit (not shown in the figure, please refer to the triangular prism shown in FIG. 2), and each first sub-electrode 125 and each corresponding second sub-electrode apply a voltage to the area of the liquid crystal layer 121 therebetween. Along a light path, a first deflection unit of a plurality of deflection units may be configured to acquire the first optical signal s1, and a last deflection unit of the plurality of deflection units may be configured to output the second optical signal s2. An input optical signal of a particular deflection unit comes from an output optical signal of a deflection unit in front of the particular deflection unit. For each deflection unit, there is an angle between the propagation direction of the output optical signal output by the deflection unit and the propagation direction of the input optical signal acquired by the deflection unit.

Further, the angle between the propagation direction of the output optical signal output by the deflection unit and the propagation direction of the input optical signal acquired by the deflection unit may not be zero.

That is, by setting a plurality of cascaded deflection units, the first optical signal s1 can be gradually deflected to increase the angle of the second direction relative to the first direction, thereby increasing a radiation angle and a coverage area of the first scanning plane 13, so that the first scanning plane 13 is not limited to the front of the scanning module 12 along the first direction. Since the angle of each deflection unit to the input optical signal can be relatively small, the voltage V applied by each deflection unit can be appropriately reduced, which is conducive to reducing the power consumption of lase radar 1.

In some embodiments, the plurality of first sub-electrodes 125 may be disposed on the same line, and correspondingly, the plurality of second sub-electrodes may also be disposed on the same line.

Alternatively, the plurality of first sub-electrodes 125 may be scattered on the same plane to realize different angles of the second direction relative to the first direction according to requirements, as shown in FIG. 4.

In some embodiments, the spacing between two adjacent first sub-electrodes 125 in the plurality of first sub-electrodes 125 may be the same, and correspondingly, the spacing between two adjacent second sub-electrodes in the plurality of second sub-electrodes may be the same.

Alternatively, the plurality of first sub-electrodes 125 may not be equally spaced, and similarly, the plurality of second sub-electrodes 125 may not be equally spaced.

In some embodiments, the shapes of the first sub-electrodes 125 may be the same or different as long as the shapes and areas of the first sub-electrode 125 and the corresponding second sub-electrode 125 are the same.

In some embodiments, the voltages applied by the first sub-electrodes 125 and the second sub-electrodes of different deflection units to the area of the liquid crystal layer therebetween may be different.

In some embodiments, the plurality of deflection units may include a first group of deflection units and a second group of deflection units, wherein the angle between the propagation direction of the output light signal and the input light signal of each deflection unit included in the first group of deflection units may be different from the angle between the output light signal and input light signal of each deflection unit included in the second group of deflection units.

For example, the shape of the sub-electrodes of the first group of deflection units may be different from that of the sub-electrodes of the second group of deflection units.

For another example, an electrode voltage applied by the sub-electrodes of the first group of deflection units may be different from that applied by the sub-electrodes of the second group of deflection units.

For another example, the change An of the refractive index of the liquid crystal layer 121 surrounded by the first group of deflection units may be different from that of the liquid crystal layer 121 surrounded by the second group of deflection units.

In some embodiments, using IPS technology, the plurality of first sub-electrodes 125 and the plurality of second sub-electrodes may be arranged on the same side of the liquid crystal layer 121 along the z direction.

In some embodiments, a plurality of scanning modules 12 are provided, and the first scanning planes 13 of the plurality of scanning modules 12 are mutually orthogonal. For example, the plurality of scanning modules 12 include multiple groups of scanning modules 12, each group of scanning modules 12 include two scanning modules 12 which are mutually orthogonal, thereby realizing the scanning for three-dimensional space.

Further, each scanning module 12 may be operated independently.

Alternatively, the plurality of scanning modules 12 may be operated synchronously.

In a typical application scenario, considering that there may be a slight delay in the orientation change of the liquid crystal material with the change of the voltage V, when the laser radar 1 is applied to static or low-speed scene such as monitoring, the liquid crystal material filled in the liquid crystal layer 121 may be realized by using an ordinary liquid crystal material, so as to take full advantage of the characteristic of low price of the ordinary liquid crystal and greatly reduce the cost of laser radar 1.

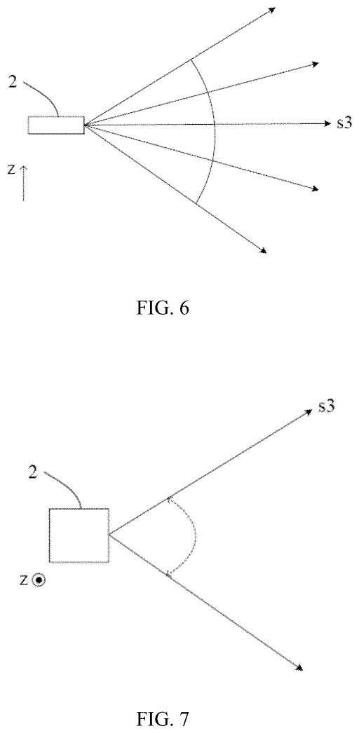

When the laser radar 1 is applied to high-speed scenes with high requirements for scanning frequency, such as automobiles, a blue phase liquid crystal material may be used, which has a fast response speed to the change of the voltage V, or special optical design (such as the multi-beam-based liquid crystal scanning array shown in FIG. 6) is adopted to reduce requirements for the scanning speed of a single laser beam.

FIG. 5 is a partial schematic diagram of the principle of a laser radar 2 according to another embodiment of the present disclosure. Here, only the differences between the laser radar 2 and the laser radar 1 shown in FIGS. 1 to 3 are explained, and a detector 14 is not shown in FIG. 5.

In this embodiment, the main difference from the above-mentioned laser radar 1 is that the laser radar 2 may further include a shaper 21 disposed in front of the scanning module 12 along the second direction. The shaper 21 may be configured to acquire the second optical signal s2 and output a single or a plurality of third optical signals s3, and the single or the plurality of third optical signal s3 is in a second scanning plane 22.

Further, the second scanning plane 22 may have a preset angle relative to the first scanning plane 13, and the preset angle may not be zero.

Specifically, the shaper 21 may be a beam shaper (also referred to as a shaping optical device). In some embodiment, by adding the shaper 21 to realize surface scanning of the target object a, the cost is low and it is easy to realize.

In some embodiments, the shaper 21 may convert the incident second optical signal s2 into the plurality of third optical signal s3. For example, the shaper 21 may be an optical splitter. For example, the second optical signal s2 may include a deflected light beam (or a plurality of relatively concentrated deflected light beams). When the deflected light beam passes through the optical splitter, it diverges under the action of the beam splitter, so that the plurality of third optical signal s3 emitted from the optical splitter can be transmitted along the second scanning plane 22.

In a variation, the shaper 21 may only perform a collimation function to shape the transmission direction of the second optical signal s2 into a direction more suitable for scanning the target space. For example, the shaper 21 may be a specially designed lens group. The lens group may include a cylindrical lens.

Further, by setting the placement angle of the shaper 21, a shaping plane 22 may have an angle that is not zero relative to the first scanning plane 13.

In practical applications, different shapers 21 may be designed according to the scene to be detected to optimize the detection performance. In a typical application scenario, referring to FIGS. 6 and 7, the shaper 21 may be designed in such a way that cross-sections of the emitting beam of the laser radar 2 in the horizontal direction (as shown in FIG. 7) and in the vertical direction (as shown in FIG. 6) can all be sector beams, so that two independent devices can be simulated on the same laser radar device to scan two spatial direction angles. The cross-section of the emitting beam of the laser radar 2 in the horizontal direction may be in the first scanning plane 13, and the cross-section of the emitting beam of the laser radar 2 in the vertical direction (the z direction in the figure) may be in the second scanning plane 22.

As shown in FIGS. 1 to 3, the laser radar 1 performs line scanning with the second optical signal s2, and the scanning result of the target object a is the area where the first scanning plane 13 intersects the target object a. In contrast, the laser radar 2 in this embodiment shapes the second optical signal s2 into the third optical signals s3 transmitted along the shaping plane 22 by the shaper 21. Therefore, as the voltage V changes, the laser radar 2 performs spatial (three-dimensional) scanning for the target object a by surface scanning.

In a variation, the first optical signal s1 may include a single or a plurality of incident light beams, and correspondingly, the second optical signal s2 may include a single or a plurality of deflected light beams, and the deflected light beams correspond to the incident light beams one by one.

Further, the shaper 21 can be configured to obtain at least part of the deflected light beams in the single or the plurality of deflected light beams and output the single or the plurality of third optical signals s3.

In other words, the shaper 21 may only shape a part of the laser beams in the second optical signal s2 output by the scanning module 12, so that the laser radar 2 can scan the target space by line scanning and surface scanning simultaneously.

For example, the laser generation module 11 may include a plurality of laser devices, and each laser device can emit a laser beam, and a plurality of laser beams emitted by the plurality of laser devices form the plurality of incident light beams.

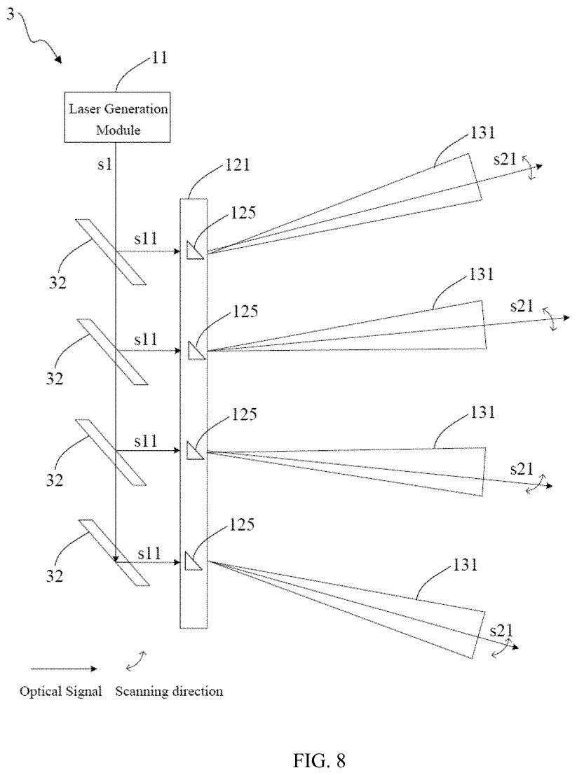

FIG. 8 is a partial schematic diagram of a laser radar 3 according to still another embodiment of the present disclosure. Here, only the differences between the laser radar 3 and the laser radar 1 shown in FIGS. 1 to 3 are described.

In this embodiment, the main difference from the laser radar 1 is that the first optical signal s1 may include a plurality of incident light beams s11, and the second optical signal s2 may include a plurality of deflected light beams s21. The incident light beams s11 correspond to the deflected light beams s21 one by one. The first electrode 123 may include a plurality of first sub-electrodes 125, and the second electrode 124 may include a plurality of second sub-electrodes (not shown). The plurality of first sub-electrodes 125 and the plurality of second sub-electrodes are disposed opposite to each other on both sides of the liquid crystal layer 121 along the longitudinal direction (the z direction in the figure). Each first sub-electrode 125, each corresponding second sub-electrode and an area of the liquid crystal layer 121 between the first sub-electrode 125 and the second sub-electrode along the longitudinal direction (the z-direction shown) form a deflection unit (not shown in the figure, please refer to the triangular prism in FIG. 2), and each first sub-electrode 125 and the corresponding second sub-electrode may apply a voltage to the area of the liquid crystal layer 121 therebetween, and each deflection unit may be configured to acquire the corresponding incident light beams s11 and output the deflected light beams s21.

For example, a single laser beam (such as the first optical signal s1) generated by the laser generation module 11 can be converted into the plurality of incident light beams s11 by setting a plurality of beam splitters 32, and each incident light beam s11 is input into the corresponding deflection unit.

In some embodiments, shapes and areas of the sub-electrodes of different deflection units may be the same or different.

Further, for different deflection units, the angles between the output deflected light beams s21 and the input incident light beams s11 may be the same or different.

In some embodiments, for each deflection unit, the transmission direction of the deflected light beam s21 output by the deflection unit changes with the change of the voltage V of the deflection unit to form a sub-scanning plane 131. The sub-scanning plane 131 formed by the plurality of deflection units covers the first scanning plane 13. Therefore, the first scanning plane 13 can be formed by a liquid crystal scanning array, and since the sub-scanning plane 131 formed by each deflection unit may be relatively small, the voltage V applied by each deflection unit can be appropriately reduced, which is beneficial to reduce the power consumption of the laser radar 3.

In some embodiments, the areas of the sub-scanning planes 131 formed by different deflection units may be different. For example, by configuring different deflection units to apply different voltages V, or by configuring different deflection units to have different shapes and areas, the areas of the sub-scanning planes 131 can be changed.

In some embodiments, there may be an intersecting scanning area between adjacent sub-scanning planes 131 to avoid scanning blind spots.

In some embodiments, the deflection directions and angles of the deflected light beams s21 may be adjusted at the same speed in each deflection unit. That is, the scanning speeds and scanning directions of the deflected light beams s21 in respective sub-scanning planes 31 are synchronous.

In a variation, each deflection unit may independently control the scanning speeds and scanning directions of the deflected light beams s21 in the corresponding sub-scanning plane 131.

From the above, the multi-beam-based liquid crystal scanning array shown in FIG. 6 can be applied to high-speed application scenarios. Since a single scanning stroke of the single deflected light beam s21 is only in the corresponding sub-scanning plane 131, the time for completing a single scanning is greatly reduced, and the scanning frequency of the laser radar 3 is optimized.

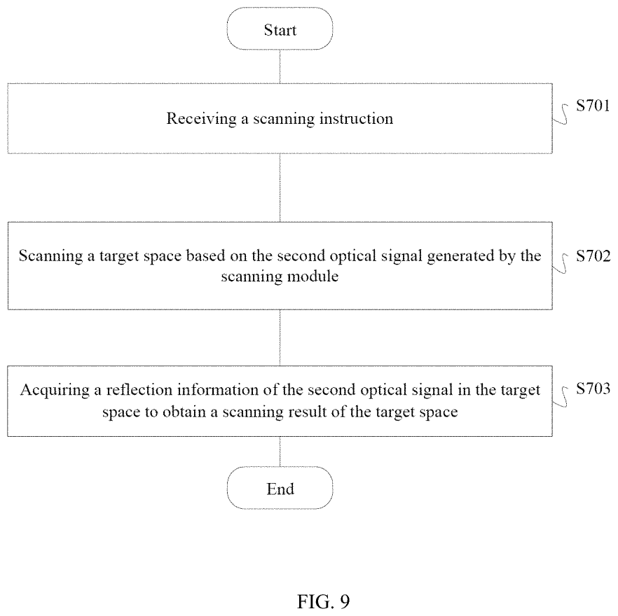

FIG. 9 is a flowchart of a scanning method of the laser radar according to an embodiment of the present disclosure. The laser radar described in this embodiment may be the laser radar as described in the embodiments shown in FIGS. 1 to 8.

Specifically, referring to FIG. 9, the scanning method described in this embodiment may include following steps:

S701, receiving a scanning instruction;

S702, scanning the target space based on the second optical signal s2 generated by the scanning module 12;

S703: acquiring a reflection information of the second optical signal s2 in the target space to obtain a scanning result of the target space.

In some embodiments, the scanning method further includes: applying the voltage v to the liquid crystal layer 121 in response to receiving a scanning instruction, wherein the voltage changes according to a preset waveform and a preset frequency.

In some embodiments, the preset frequency is greater than 0 and less than or equal to 10 KH.

In some embodiments, the preset waveform may include a pulse wave. The pulse wave may be a triangular wave, a trapezoidal wave or a sawtooth wave.

The preset waveform may also include a nonlinear wave. The nonlinear wave may be a sine wave or a cosine wave.

In some embodiments, the change of the voltage V may be related to an angular resolution of the laser radar 1 (or the laser radar 2 or the laser radar 3).

Specifically, a change of the angle is positively related to a waveform and a change of the voltage.

A change of the refractive index of the liquid crystal layer 121 is positively related to the waveform and the change of the voltage, and the change Δn of the refractive index of the liquid crystal layer 121 refers to the change of the refractive index of the portion of the liquid crystal layer 121 applied with the voltage before and after the voltage is applied.

In some embodiments, the waveform of the voltage may be in any function form, and the specific waveform can be adjusted according to the scanning requirements of the target space. For example, the waveform may be a linearly changing wave such as a trapezoidal wave, a triangular wave, and the like. For another example, the waveform may also be a wave with a curvature change, such as a sine wave, a tangent function wave, and the like.

Specifically, in a small signal area, a voltage of a triangular wave may be applied to achieve uniform scanning. The small signal area may refer to an application scenario where the electric field intensity applied to the liquid crystal layer 121 is less than 3×10⁶ V/m. As the intensity of the electric field further increases, the change of the angle, the change An of the refractive index of the liquid crystal layer 121 and the change of the voltage V may no longer have a strict linear relationship. At this time, the waveform of the voltage V can be adjusted appropriately to correct the scanning deviation caused by nonlinear changes.

In some embodiments, the scanning instruction may include an area range and a scanning frequency of the target space, etc.. In response to receiving the scanning instruction, the laser radar 1 may select an appropriate waveform and preset frequency according to the scanning instruction to perform a scanning operation.

In some embodiments, the reflection information may be received by the detector 14 to obtain the scanning result. Specifically, the scanning result may be obtained by using a phase modulation method according to the reflection information, but the embodiment of the present disclosure is not limited thereto, and obtaining the scanning result includes obtaining the position and distance of an obstacle relative to the laser radar.

Although the present disclosure has been disclosed above, the present disclosure is not limited thereto. Any changes and modifications may be made by those skilled in the art without departing from the spirit and scope of the present disclosure, and the scope of the present disclosure should be determined by the appended claims.

1. A laser radar, comprising:
a laser generation module configured for generating a first optical signal; and
a scanning module configured for acquiring the first optical signal and outputting a second optical signal, wherein there is an angle between a transmission direction of the second optical signal and a transmission direction of the first optical signal, and the angle is adjustable;
wherein the scanning module comprises a liquid crystal layer configured for adjusting the angle to scan a target space.

2. The laser radar according to claim 1, wherein the second optical signal scans the target space in a first scanning plane, the laser radar further comprises a shaper configured for acquiring the second optical signal and outputting a single or a plurality of third optical signals, and the single or the plurality of third optical signals are in a second scanning plane.

3. The laser radar according to claim 2, wherein the first optical signal comprises a single or a plurality of incident light beams, the second optical signal comprises a single or a plurality of deflected light beams having a one-to-one correspondence to the single or the plurality of incident light beams, and the shaper is configured for acquiring at least a part of the deflected light beams and output the single or the plurality of third optical signals.

4. The laser radar according to claim 1, wherein the liquid crystal layer is configured for adjusting the angle under a voltage input.

5. The laser radar according to claim 4, wherein the scanning module further comprises a voltage input module configured to apply a voltage to at least a portion of the liquid crystal layer.

6. The laser radar according to claim 5, wherein the angle between the transmission direction of the second optical signal and the transmission direction of the first optical signal is determined according to one or more of following parameters: a refractive index of the liquid crystal layer before and after the voltage is applied; for the at least a portion of the liquid crystal layer applied with the voltage, a change of the refractive index of the at least a portion of the liquid crystal layer when the voltage is applied compared with the refractive index of the at least a portion of the liquid crystal layer when the voltage is not applied; an incident angle of the first optical signal on an interface on which the first optical signal is refracted and converted into the second optical signal; and an emergence angle of the second optical signal on the interface.

7. The laser radar according to claim 5, wherein the voltage input module comprises a first electrode and a second electrode, and the voltage is applied to the liquid crystal layer via the first electrode and the second electrode.

8. The laser radar according to claim 7, wherein the first electrode and the second electrode are oppositely disposed on the same side or both sides of the liquid crystal layer along a longitudinal direction, and there is a non-zero angle between the longitudinal direction and the transmission direction of the first optical signal.

9. The laser radar according to claim 8, wherein in addition to a surface facing the first electrode and the second electrode, the liquid crystal layer further comprises a plurality of surfaces, the first optical signal is transmitted to the liquid crystal layer from any of the plurality of surfaces, and the second optical signal is emitted from any of the plurality of surfaces.

10. The laser radar according to claim 7, wherein the first electrode and the second electrode are respectively in contact with the at least a portion of the liquid crystal layer, and an outer profile of a contact surface of the first electrode and/or the second electrode with the at least a portion of the liquid crystal layer is defined by a closed curve with a preset geometric shape.

11. The laser radar according to claim 8, wherein the first electrode comprises a plurality of first sub-electrodes, the second electrode comprises a plurality of second sub-electrodes, and the plurality of first sub-electrodes and the plurality of second sub-electrodes are disposed opposite to each other on the same side or both sides of the liquid crystal layer along the longitudinal direction;
wherein each first sub-electrode, each corresponding second sub-electrode and an area of the liquid crystal layer between the first sub-electrode and the corresponding second sub-electrode along the longitudinal direction form a deflection unit, and each first sub-electrode and each corresponding second sub-electrode are configured to apply a voltage to the area of the liquid crystal layer therebetween; and
wherein along a light path a first deflection unit of a plurality of deflection units is configured to acquire the first optical signal, a last deflection unit of the plurality of deflection units is configured to output the second optical signal, an input optical signal of a particular deflection unit of the plurality of deflection units comes from an output optical signal of a deflection unit in front of the particular deflection unit, and for each deflection unit, there is an angle between a propagation direction of the output optical signal output by the deflection unit and a propagation direction of the input optical signal acquired by the deflection unit.

12. The laser radar according to claim 11, wherein the plurality of deflection units comprise a first group of deflection units and a second group of deflection units, and the angle between propagation directions of the output optical signal and the input optical signal of each deflection unit included in the first group of deflection units is different from the angle between propagation directions of the output optical signal and the input optical signal of each deflection unit included in the second group of deflection units.

13. The laser radar according to claim 11, wherein the first sub-electrodes and the second sub-electrodes of different deflection units apply different voltages to the areas of the liquid crystal layer therebetween.

14. The laser radar according to claim 8, wherein the first optical signal comprises a plurality of incident light beams, the second optical signal comprises a plurality of deflected light beams having a one-to-one correspondence to the plurality of incident light beams;
wherein the first electrode comprises a plurality of first sub-electrodes, the second electrode comprises a plurality of second sub-electrodes, and the plurality of first sub-electrodes and the plurality of second sub-electrodes are disposed opposite to each other on both sides of the liquid crystal layer along the longitudinal direction;
wherein each first sub-electrode, each corresponding second sub-electrode and an area of the liquid crystal layer between the first sub-electrode and the corresponding second sub-electrode along the longitudinal direction form a deflection unit, each first sub-electrode and each corresponding second sub-electrode are configured to apply a voltage to the area of the liquid crystal layer therebetween, and each deflection unit is configured to acquire a corresponding incident light beam and outputting a deflected light beam.

15. The laser radar according to claim 14, wherein for each deflection unit, a transmission direction of the deflected light beam output by the deflection unit changes with change of the voltage applied to the deflection unit to form a sub-scanning plane, and a plurality of sub-scanning planes formed by a plurality of deflection units cover a scanning plane of the scanning module.

16. The laser radar according to claim 15, wherein the plurality of sub-scanning planes formed by different deflection units have different areas.

17. The laser radar according to claim 14, wherein the laser radar further comprises a beam splitter configured for converting a single laser beam generated by the laser generation module into the plurality of incident light beams; or the laser generation module comprises a plurality of laser devices, wherein each laser device is configured to generate a laser beam, and a plurality of laser beams generated by the plurality of laser devices form the plurality of incident light beams.

18. The laser radar according to claim 8, further comprising a cover plate disposed on one or both sides of the liquid crystal layer along the longitudinal direction, wherein the first electrode and the second electrode are disposed on the cover plate.

19. The laser radar according to claim 1, comprising a plurality of scanning modules, wherein there is an orthogonal relationship among scanning planes of the plurality of scanning modules.

20. The laser radar according to claim 1, wherein the liquid crystal layer is made of a material comprising a blue phase liquid crystal material.

21. A scanning method of the laser radar according to claim 1, comprising:
receiving a scanning instruction;
scanning the target space based on the second optical signal generated by the scanning module; and
acquiring a reflection information of the second optical signal in the target space to obtain a scanning result of the target space.

22. The scanning method according to claim 21, further comprising: applying the voltage to the liquid crystal layer in response to receiving a scanning instruction, wherein the voltage changes according to a preset waveform and a preset frequency.

23. The scanning method according to claim 22, wherein the preset frequency is greater than 0 and less than or equal to 10 KHz; and/or
the preset waveform comprises a pulse wave or a nonlinear wave.

24. The scanning method according to claim 21, wherein a change of the angle is positively related to a waveform and a change of the voltage, a change of the refractive index of the liquid crystal layer is positively related to the waveform and the change of the voltage, and the change of the refractive index of the liquid crystal layer refers to the change of the refractive index of a portion of the liquid crystal layer when the voltage is applied compared with the refractive index of the portion of the liquid crystal layer when the voltage is not applied.
